(19) United States
(12) Patent Application Publication
(10) Pub. No.: US 2016/0357708 A1
(43) Pub. Date: Dec. 8, 2016

(54) DATA ANALYSIS METHOD, DATA ANALYSIS APPARATUS, AND RECORDING MEDIUM HAVING RECORDED PROGRAM

(71) Applicant: Panasonic Intellectual Property Corporation of America, Torrance, CA (US)

(72) Inventors: HIDEO UMETANI, Osaka (JP); IKU OHAMA, Osaka (JP); RYOTA FUJIMURA, Kanagawa (JP); YUKIE SHODA, Osaka (JP)

(21) Appl. No.: 15/169,767

(22) Filed: Jun. 1, 2016

(30) Foreign Application Priority Data
Jun. 5, 2015 (JP) 2015-115084
Feb. 4, 2016 (JP) 2016-020209

(51) Int. Cl. G06F 17/16

(52) U.S. Cl. CPC G06F 17/16

(57) ABSTRACT

A data analysis method decomposes a fundamental matrix with N rows and M columns indicating relatedness with each of first N objects and each of second M objects into three matrices, and clusters at least the first objects or the second objects. The data analysis method includes acquiring the fundamental matrix having each element storing a value indicating the relatedness, setting K indicating a number of clusters of the first N objects and L indicating a number of clusters of the second M objects, decomposing the fundamental matrix into three matrices which are a first matrix, a second matrix, and a third matrix such that a product of the first matrix, the second matrix, and the third matrix approximates the fundamental matrix, and outputting at least one of clustering results of the first objects and the second objects.

### BACKGROUND

1. Technical Field

The present disclosure relates to a data analysis method, a data analysis apparatus, and a recording medium having recorded a program.

2. Description of the Related Art

Networks are in widespread use today, and a variety of data is collected and stored using various devices. The variety of data may include access information used to access a web site, purchase history of customers, recording and viewing history of programs, or information related to ages and sexes of customers. Using the purchase history or the recording history, from among these pieces of information, recommendation service is performed by clustering users according to attributes, such as preference, and by offer a product to the users. Currently disclosed clustering methods are matrix decomposition methods including non-negative matrix factorization (NMF) and tri-NMF that is an extended version of NMF as described in the paper “Orthogonal Nonnegative Matrix Tri-factorizations for Clustering”. According to this paper, matrix decomposition is performed such that the product of three matrices approximates a matrix serving as input data, and clustering is performed using one of the three matrices.

### SUMMARY

In one general aspect, the techniques disclosed here feature a data analysis method that decomposes a fundamental matrix with N rows and M columns indicating relatedness with each of first N objects and each of second M objects into three matrices, and clusters at least the first objects or the second objects. The data analysis method includes

acquiring the fundamental matrix having each element storing a value indicating the relatedness,

setting K indicating a number of clusters of the first N objects and L indicating a number of clusters of the second M objects,

decomposing the fundamental matrix into three matrices which are a first matrix, a second matrix, and a third matrix such that a product of the first matrix, the second matrix, and the third matrix approximates the fundamental matrix, the first matrix having N rows and K columns, the second matrix having K rows and L columns with each element at least one of a particular row and a particular column thereof storing a value falling within a predetermined range, the third matrix having L rows and M columns, and

outputting at least one of clustering results of the first objects and the second objects by outputting at least one of the first matrix, the second matrix, and the third matrix.

The data analysis method, the data analysis apparatus, and the recording medium having recorded program, according to the disclosure, performs clustering that reflects a variety of information.

It should be noted that general or specific embodiments may be implemented as a system, a method, an integrated circuit, a computer program, a computer readable storage medium, such as a compact disk read-only memory (CD-ROM), or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram diagrammatically illustrating a data analysis system that performs a data analysis method of a first embodiment;

FIG. 2 illustrates an example of a fundamental matrix of the first embodiment;

FIG. 3 illustrates the fundamental matrix as a modification of the first embodiment;

FIG. 4 is a block diagram diagrammatically illustrating a data analysis apparatus of the first embodiment;

FIGS. 5A through 5D respectively illustrate the concepts of a fundamental matrix, a first matrix, a second matrix, and a third matrix of the first embodiment;

FIG. 6 is a flowchart illustrating a routine of the data analysis method of the first embodiment;

FIG. 7 is a flowchart illustrating a routine of a decomposition process of the first embodiment;

FIG. 8 illustrates an example of the fundamental matrix of the first embodiment;

FIGS. 9A through 9C respectively illustrate the first matrix, the second matrix, and the third matrix obtained from the fundamental matrix of FIG. 8 through the data analysis method;

FIG. 10 is a flowchart illustrating a routine of a decomposition process of a second embodiment;

FIG. 11 is a flowchart illustrating a routine of a deletion process of the second embodiment; and

FIG. 12 is a block diagram illustrating a data analysis apparatus of a modification of the second embodiment.

### DETAILED DESCRIPTION

Underlying Knowledge Forming Basis of the Present Disclosure

The inventor has learned that the method described in the “description of the related art” section suffers from the following problem.

When the purchase history or the program recording history is collected, the data to be collected may include information, such as “a person has purchased a product” or “a person has recorded a program”, and information, such as “a product has not been purchased” or “a program has not been recorded”, is not directly collected. For convenience of explanation, the collected data is the program recording history in the following discussion. Since the information “the program has been recorded” is accumulated, the information “the program has not been recorded” is derived from performing an inverse operation of “the program has not been stored”=“the program has not been recorded”. More specifically, the information “the program has been recorded” may be interpreted to mean that “the program has been recorded because the user likes it”. However, the information “the program has not been recorded” may be interpreted in two different ways. Namely, the information “the program has not been recorded” may indicate that “the program has not been recorded because the user does not like it” or may indicate that “the program has not been recorded because the user does not know the presence of the program”. In the method disclosed in the paper “Orthogonal Nonnegative Matrix Tri-factorizations for Clustering”, the information “the program has not been recorded” open to two different interpretations is not accounted for, and clustering is performed in view of only the information based on the assumption that “the program has been recorded” =“the user likes that program”. In other words, the information that “the user does not like the program” is not accounted for.

The disclosure provides a data analysis method, a data analysis apparatus, and a non-transitory computer-readable recording medium.

The clustering operation that reflects a variety of information is performed by accounting for the information that “a user does not like a program”.

According to an aspect of the disclosure, there is provided a data analysis method that decomposes a fundamental matrix with N rows and M columns indicating relatedness with each of first N objects and each of second M objects into three matrices, and clusters at least the first objects or the second objects. The data analysis method includes acquiring the fundamental matrix having each element storing a value indicating the relatedness, setting K indicating a number of clusters of the first N objects and L indicating a number of clusters of the second M objects, decomposing the fundamental matrix into three matrices which are a first matrix, a second matrix, and a third matrix such that a product of the first matrix, the second matrix, and the third matrix approximates the fundamental matrix, the first matrix having N rows and K columns, the second matrix having K rows and L columns with each element at least one of a particular row and a particular column thereof storing a value falling within a predetermined range, the third matrix having L rows and M columns, and outputting at least one of clustering results of the first objects and the second objects by outputting at least one of the first matrix, the second matrix, and the third matrix.

In this method, the clustering operation that reflects a factor for which the user has not acquired an object is performed. The clustering operation thus reflects a variety of information.

Each element at the particular row and each element at the particular column may store a value falling within the predetermined range.

Since a value falling within the predetermined range is stored at each element at the particular row and the particular column of the second matrix, the clustering operation that reflects different pieces of information (a degree of recognition of an object and an acquisition frequency by a user) is thus performed.

The value falling within the predetermined range is a positive value being approximately zero.

Since the value falling within the predetermined range is a positive value being approximately zero, relatedness with the clusters is reduced to almost non-existence, and a value reflecting a variety of information is thus derived.

Sums of all rows of the first matrix, each sum being a sum of the values of the elements at each row, may be approximately equal to each other.

Since the sums of all rows of the first matrix are approximately equal to each other, the values at the columns of the first matrix are easily compared with each other.

Sums of all columns of the third matrix, each sum being a sum of the values of the elements at each column, may be approximately equal to each other.

Since the sums of all columns of the third matrix are approximately equal to each other, the values at the rows of the third matrix are easily compared with each other.

The decomposing may include iterating updating the first matrix, the second matrix, and the third matrix such that a difference between the product of the first matrix, the second matrix, and the third matrix and the fundamental matrix decreases.

Since the first matrix, the second matrix, and the third matrix are updated such that the difference between the product of the first matrix, the second matrix, and the third matrix and the fundamental matrix decreases, the matrix decomposition is smoothly performed.

The decomposing may include updating the first matrix, the second matrix, and the third matrix respectively into the first matrix with N rows and (K−1) columns, the second matrix with (K−1) rows and L columns, and the third matrix with L rows and M columns by deleting a k-th row of the second matrix, and a k-th column of the first matrix if a value at each element at the k-th row from among rows other than the particular row of the second matrix falls within the predetermined range.

The clustering operation is performed with a higher clustering precision at a higher process speed.

The decomposing may include updating the first matrix, the second matrix, and the third matrix respectively into the first matrix with N rows and K columns, the second matrix with K rows and (L−1) columns, and the third matrix with (L−1) rows and M columns by deleting an l-th column of the second matrix, and an l-th row of the third matrix if a value at each element at the l-th column from among columns other than the particular column of the second matrix falls within the predetermined range.

The clustering operation is performed with a higher clustering precision at a higher process speed.

The first object may be a user, and the relatedness with each element in the fundamental matrix may represent the presence or absence of each of the N users' interest in each of the second M objects. At least one of the acquiring, the setting, the decomposing and the outputting may be performed by a processor.

According another aspect of the disclosure, there is provided a data analysis apparatus that decomposes a fundamental matrix with N rows and M columns indicating relatedness with each of first N objects and each of second M objects into three matrices, and clusters at least the first objects or the second objects. The data analysis apparatus includes an acquirer that acquires the fundamental matrix having each element storing a value indicating the relatedness, a setter that sets K indicating a number of clusters of the N first objects and L indicating a number of clusters of the second M objects, a decomposer that decomposes the fundamental matrix into three matrices which are a first matrix, a second matrix, and a third matrix such that a product of the first matrix, the second matrix, and the third matrix approximates the fundamental matrix, the first matrix having N rows and K columns, the second matrix having K rows and L columns with each element at least one of a particular row and a particular column thereof storing a value falling within a predetermined range, the third matrix having L rows and M columns, and an outputter that outputs at least one of clustering results of the first objects and the second objects by outputting at least one of the first matrix, the second matrix, and the third matrix.

The data analysis apparatus performs the clustering operation that reflects a factor for which the user has not acquired an object. The clustering operation thus reflects a variety of information.

According to another aspect of the disclosure, there is provided a non-transitory computer-readable recording medium. The non-transitory computer-readable recording medium stores a program that causes a computer to perform the data analysis method.

The clustering operation that reflects a factor for which the user has not acquired an object is performed. The clustering operation thus reflects a variety of information.

It should be noted that general or specific embodiments may be implemented as a system, a method, an integrated circuit, a computer program, a non-transitory computer-readable recording medium, such as a compact-disk read-only memory (CD-ROM), or any selective combination thereof.

### First Embodiment

A data analysis method of a first embodiment is specifically described with reference to the drawings. Each of the embodiments described below represents a general or specific example of the disclosure. Numerical values, shapes, materials, elements, layout locations of the elements, connection configuration of the elements, steps and the order of the steps in the embodiments are described for exemplary purposes only, and are not intended to limit the disclosure. Elements not described in independent claims indicative of a generic concept, from among the elements of the embodiments, may be optional elements.

Configuration of Entire System

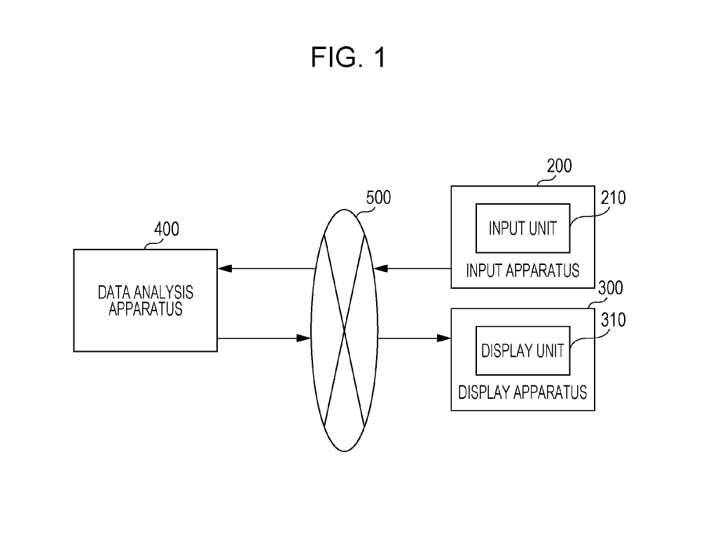

FIG. 1 is a block diagram diagrammatically illustrating a data analysis system 1 that performs a data analysis method of a first embodiment.

The data analysis system 1 decomposes a fundamental matrix with N rows and M columns indicating the presence or absence of each of N users' interest in each of M objects into three matrices to cluster the users. The objects may be those in which the users may be interested, and, for example, include a product that may be purchased by a user, or the user may rent, a television program or a radio program that may be viewed or recorded by the user. The presence or absence of the user's interest is determined as below. If a product is purchased, the user's interest is determined to be present while if the product is not purchased, the user's interest is determined to be absent. On the other hand, if the object is a program, viewing the program or recording the program indicates that the user's interest is present and not viewing the program or not recording the program indicates that the user's interest is absent.

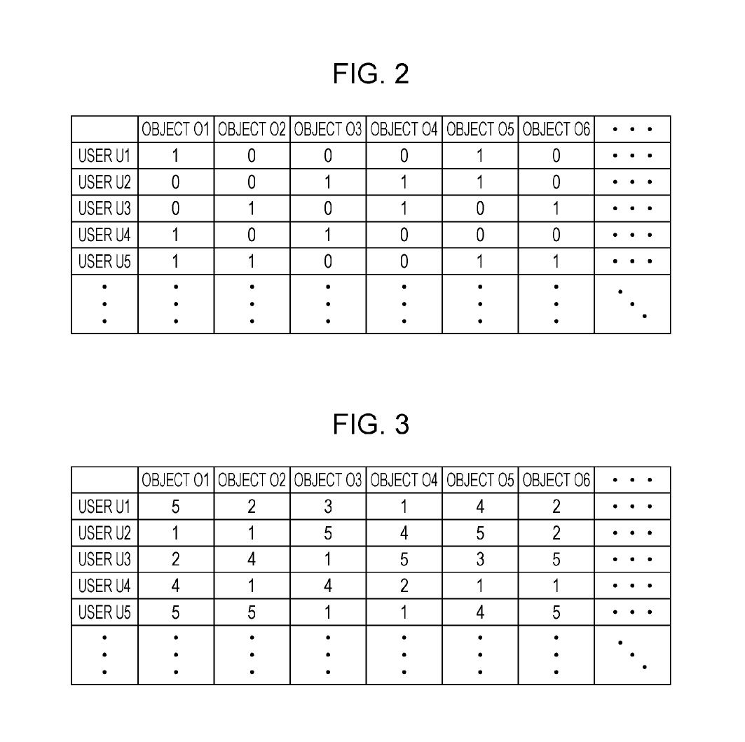

FIG. 2 illustrates an example of a fundamental matrix of the first embodiment.

The fundamental matrix of FIG. 2 indicates the presence or absence of user's interest of each of N users U1, U2, U3, U4, U5, . . . , UN concerning each of M objects O1, O2, O3, O4, O5, O6, . . . , OM Each element in the fundamental matrix stores a value indicative of the presence or absence of each user's interest. More specifically, if a user is interested in an object, “1” is stored at a corresponding element, and if a user is not interested in an object, “0” is stored at a corresponding element. If the object is a program, the presence or absence of user's interest may be the presence or absence of the recorded program. An element stores “1” for a program recorded by the user, or “0” for a program not recorded by the user. Data values and format are described for exemplary purposes only, and the embodiment is not limited to the data values and format. The value input to each element is a non-negative value.

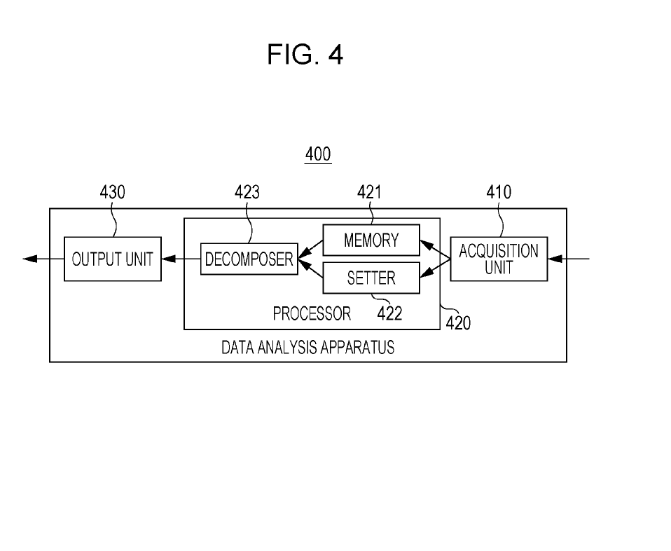

FIG. 3 illustrates the fundamental matrix as a modification of the first embodiment.

The presence of the user's interest in the program is rated on a scale from 1 to 5 in the example of FIG. 3. In this case, the value of each element may be normalized such that a maximum rating “5” becomes “1”.

The data analysis system 1 clusters the users or the objects by decomposing the fundamental matrix into three matrices.

Referring to FIG. 1, the data analysis system 1 includes an input apparatus 200, a display apparatus 300, and a data analysis apparatus 400. The input apparatus 200, the display apparatus 300, and the data analysis apparatus 400 are interconnected to each other via a network 500.

The network 500 may be a wired network, such as Ethernet (registered trademark), a wireless network, such as a wireless local area network (LAN), a public network, or a network including a combination thereof. The public network is a communication network a telecommunications carrier provides for public users. For example, the public network may be a public telephone network, or integrated services digital network (ISDN).

The input apparatus 200 receives a fundamental matrix with N rows and M columns. For example, the input apparatus 200 may be a personal computer, a smart phone, a feature phone, or a tablet terminal, each including an input unit 210, such as a keyboard, a touch panel, or a pointing device. Upon receiving the fundamental matrix with N rows and M columns, the input apparatus 200 transmits the fundamental matrix to the data analysis apparatus 400 via the network 500.

When the display apparatus 300 receives at least one of the fundamental matrix and the three matrices from the data analysis apparatus 400, the display apparatus 300 displays at least one of the matrices. The display apparatus 300 is a personal computer, a smart phone, a feature phone, or a tablet terminal, each including a display, such as a display unit 310. An analyzer may analyze the clustering results by viewing at least one matrix displayed on the display unit 310 in the display apparatus 300.

In the first embodiment, the input apparatus 200 is separate from the display apparatus 300. Alternatively, the input apparatus 200 and the display apparatus 300 may be integrated into a unitary apparatus.

Data Analysis Apparatus

The data analysis apparatus 400 decomposes the fundamental matrix with N rows and M columns into three matrices. The data analysis apparatus 400 may be a server, a personal computer, a smart phone, a feature phone, or a tablet terminal.

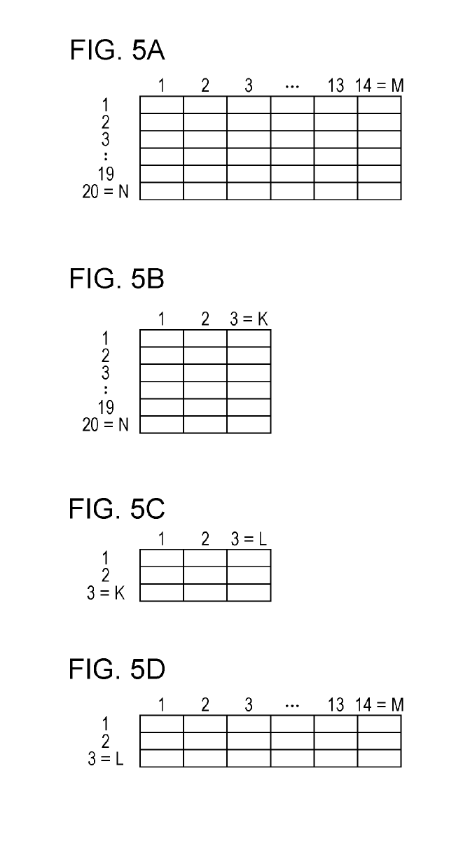

FIG. 4 is a block diagram diagrammatically illustrating the data analysis apparatus 400.

Referring to FIG. 4, the data analysis apparatus 400 includes an acquisition unit 410, a processor 420, and an output unit 430.

The acquisition unit 410 acquires the fundamental matrix input from the input apparatus 200 via the network 500, and then outputs the fundamental matrix to the processor 420.

The processor 420 decomposes the fundamental matrix input via the acquisition unit 410 into three matrices, and includes a central processing unit (CPU), a random-access memory (RAM), a read-only memory (ROM), and the like. The processor 420 includes a memory 421, a setter 422, and a decomposer 423.

The memory 421 stores the fundamental matrix input via the acquisition unit 410, and may be a non-volatile memory or a volatile memory.

The setter 422 stores a configuration item for use in a decomposition process by the decomposer 423. The configuration items may be K and L, determining the size of each of the three matrices. The configuration items also include a convergence criteria used in the decomposition process. When the decomposer 423 performs the decomposition process, the setter 422 outputs the configuration item to the decomposer 423, thereby setting the configuration item.

The configuration item may be a set value input from the input apparatus 200 in place of the configuration item pre-stored on the setter 422. In such a case, the setter 422 stores the configuration item received from the input apparatus 200 via the acquisition unit 410.

The decomposer 423 decomposes the fundamental matrix into three matrices such that the product of the first matrix, the second matrix, and the third matrix approximates the fundamental matrix. The first matrix has N rows and K columns. The second matrix has K rows and L columns with each element at least one of a particular row and a particular column storing a value falling within a predetermined range. The third matrix has L rows and M columns.

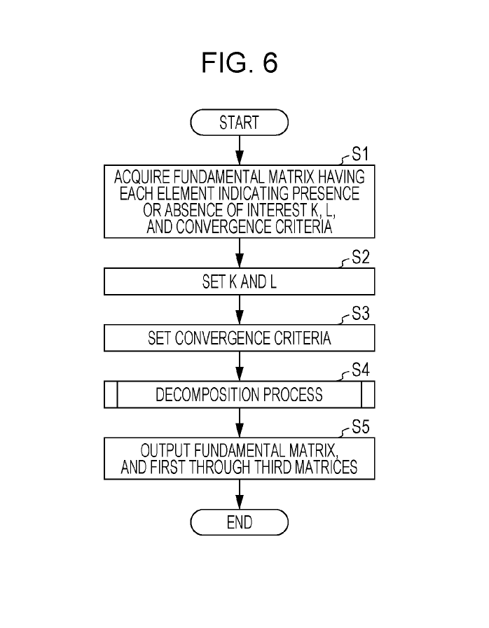

FIGS. 5A through 5D illustrate the concepts of the fundamental matrix, the first matrix, the second matrix, and the third matrix of the first embodiment.

Let the fundamental matrix have 20 (N) rows and 14 (M) columns with K=3 and L=3, and the first matrix with N rows and K columns has 20 rows and 3 columns, the second matrix with K rows and L columns has 3 rows and 3 columns, and the third matrix with L rows and M columns has 3 rows and 14 columns.

K represents the number of user clusters. L represents the number of object clusters. A column or a row of elements (clusters), not directly related to the user cluster (a first object cluster) and the object cluster (a second object cluster), is contained in a column or a row of the first matrix, the second matrix, and the third matrix.

Referring to FIGS. 5A through 5D, K representing the number of first object clusters is “3”, and L representing the number of second object clusters is “3”. In the discussion that follows, two clusters out of the three clusters are directly related to each of the first object and the second object, and the remaining one cluster is not directly related to each of the clusters. If clusters the analyzer intends to categorize are input exactly by the number of user clusters and the number of object clusters, respectively and directly related to the intended clusters, the setter 422 or the decomposer 423 may set the value of the number of clusters plus 1 (the value with an element not directly related added thereto) to be K or L.

The value falling within the predetermined range is a positive value that is zero or approximately zero. Specifically, the value falls within a range of 0 or larger to 0.1 or lower. Preferably, the value falls within a range of 0 or larger to 0.01 or smaller. As long as the values at the elements at least at one of the particular row and the particular column of the second matrix fall within the predetermined range, the values do not necessarily have to be equal to each other. In the following discussion of the first embodiment, the values at K-th row and at L-th column of the second matrix are set to be zero. Alternatively, however, the value at each element of one of the K-th row and the L-th column of the second matrix falling within the predetermined range is also acceptable. The particular row may be a row other than the K-th row and the particular column may be a column other than the L-th column.

If the value at each element at the particular column of the second matrix falls within a predetermined value, a condition that the sums of the elements at the columns, each sum being a sum of the values at the elements at each column, are approximately the same value holds true in the third matrix. On the other hand, if the value at each element at the particular row of the second matrix falls within a predetermined range, a condition that the sums of the elements at the rows, each sum being a sum of the values at the elements at each row, are approximately the same value holds true in the first matrix. Approximately the same value does not necessarily have to be the same value, but may be a value falling within a slight permissible range. Approximately the same value may be any value as long as the degree of relatedness of a user, an object, and each cluster is easy to recognize. For example, approximately the same value may be “1” or “100”.

The first matrix, the second matrix, and the third matrix are specifically described below.

The decomposer 423 repeatedly updates the first matrix, the second matrix, and the third matrix such that a difference between the product of the first matrix, the second matrix, and the third matrix and the fundamental matrix decreases. If the convergence criteria stored on the setter 422 is satisfied, the updating is complete. The convergence criteria may be determined to be satisfied as described below. In a method, the convergence criteria is determined to be satisfied if a predetermined number of iterations (1000 times) is performed. In another method, the convergence criteria is determined to be satisfied if a difference between the product of the first matrix, the second matrix, and the third matrix and the fundamental matrix is equal to or below a predetermined value (such as 1e−6). In yet another method, the convergence criteria is determined to be satisfied if a difference between the products of the first matrix, the second matrix, and the third matrix and the fundamental matrix prior to and subsequent to a single updating is equal to or below a predetermined value (such as 1e−6). The methods described above may be used alone or in combination. The difference may be a value obtained by summing values as a result of subtraction operations of the elements of the matrices, or may be a sum of squares of values resulting from the subtraction operations of the elements.

Referring to FIG. 4, the output unit 430 outputs at least one of the fundamental matrix, the first matrix, the second matrix, and the third matrix to the display apparatus 300. The output unit 430 may output some or all of the fundamental matrix, the first matrix, the second matrix, and the third matrix at a time. Alternatively, the output unit 430 may also output the difference between the product of the first matrix, the second matrix, and the third matrix and the fundamental matrix to the display apparatus 300.

Data Analysis Method

The data analysis method of the embodiment is described below.

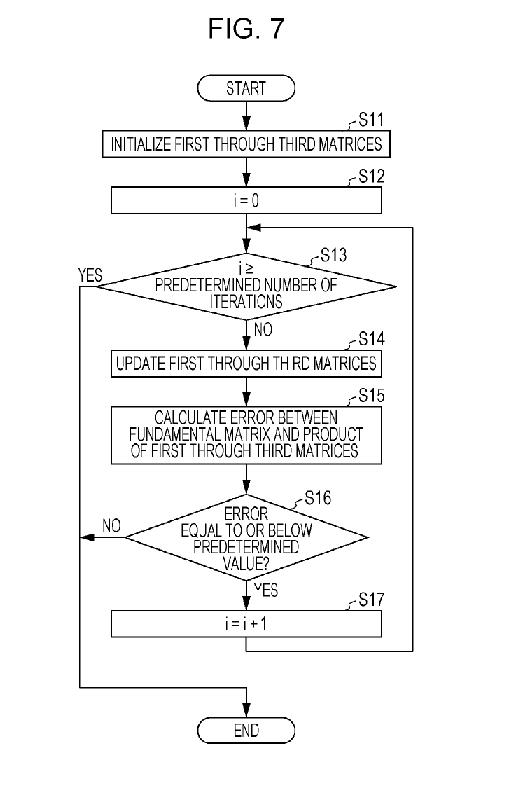

FIG. 6 is a flowchart illustrating a routine of a data analysis method of the first embodiment.

The input apparatus 200 receives a value indicative of the presence or absence of a user's interest at each element of the fundamental matrix. The input apparatus 200 also receives K, L, and the convergence criteria. Upon receiving these pieces of information, the input apparatus 200 outputs the fundamental matrix, K, L, and the convergence criteria to the data analysis apparatus 400. If the configuration item is set in the setter 422 in the data analysis apparatus 400, and is used in subsequent operations, the input apparatus 200 is free from the reception of the configuration item.

The acquisition unit 410 in the data analysis apparatus 400 acquires the fundamental matrix, L, K, and the convergence criteria input from the input apparatus 200 via the network (step S1). Subsequent to the acquisition, the acquisition unit 410 stores the fundamental matrix on the memory 421.

The setter 422 stores K, L, and the convergence criteria acquired by the acquisition unit 410 as the configuration items (steps S2 and S3).

The decomposer 423 in the data analysis apparatus 400 performs a decomposition process in accordance with the fundamental matrix and the configuration items.

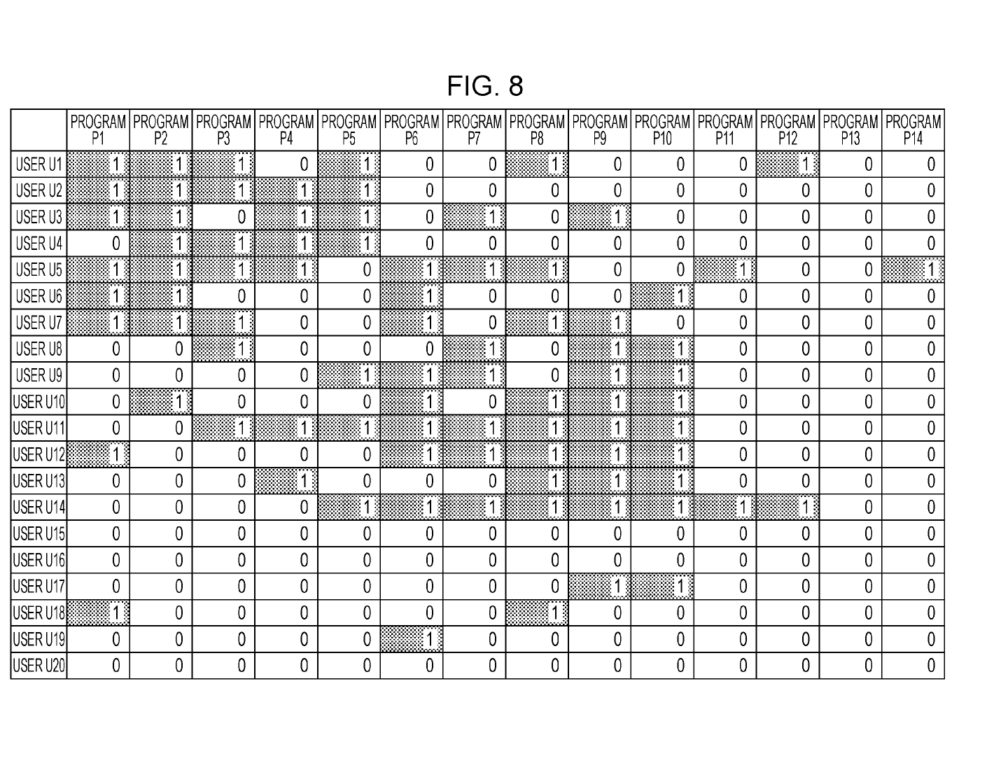

FIG. 7 is a flowchart illustrating a routine of the decomposition process of the first embodiment.

The decomposer 423 generates the first matrix, the second matrix, and the third matrix in accordance with N, M, K, and L. The decomposer 423 substitutes random numbers for the elements of the first matrix, the second matrix, and the third matrix for initialization (step S11).

The decomposer 423 sets i to be zero (step S12).

The decomposer 423 determines whether i is a predetermined number of iterations as the convergence criteria. If i is less than the predetermined number of iterations, the decomposer 423 proceeds to step S14. If i is equal to or above the predetermined number of iterations, the decomposer 423 completes the decomposition process.

In step S14, the decomposer 423 updates the first matrix, the second matrix, and the third matrix.

During the updating, the decomposer 423 updates the initialized first matrix, second matrix, and third matrix in accordance with a predetermined matrix updating formula in order to determine the first matrix, the second matrix, and the third matrix such that the product thereof approximates the fundamental matrix. During the updating, the decomposer 423 updates the second matrix such that the values at the elements at the K-th row and the L-th column are zero.

An example of the matrix updating formula is described below.

In the following matrix updating formula (1), X represents the fundamental matrix, F represents the first matrix, S represents the second matrix, and G^{T} represents the third matrix. In the following matrix updating formula (1), α, β, and γ are constants. S* represents the matrix S with the value at each element at least one of the particular row and the particular column being a value falling within a predetermined range (zero in the first embodiment).

$$\vert \vert X - {FSG}^{T} {\vert \vert}^{2} + α \vert \vert F ( \begin{matrix}1 \\ ⋮ \\ 1\end{matrix} ) - ( \begin{matrix}1 \\ ⋮ \\ 1\end{matrix} ) {\vert \vert}^{2} + β \vert \vert G ( \begin{matrix}1 \\ ⋮ \\ 1\end{matrix} ) - ( \begin{matrix}1 \\ ⋮ \\ 1\end{matrix} ) {\vert \vert}^{2} + γ \vert \vert S - {S}^{*} {\vert \vert}^{2} \qquad ( 1 )$$

The decomposer 423 updates the first matrix, the second matrix, and the third matrix such that the matrix updating forma (1) is minimized.

Examples of formulas representing the details of the matrix updating formula (1) are described below.

$$\begin{matrix}{F}_{w , k} = {F}_{w , k} \frac{{( {XG}^{T} {S}^{T} )}_{w , k} + {α ( {BA}^{T} )}_{w , k}}{{( {FSGG}^{T} {S}^{T} )}_{w , k} + {α ( {FAA}^{T} )}_{w , k}} & ( 2 ) \\ {G}_{t , l} = {G}_{t , l} \frac{{( {X}^{T} FS )}_{t , l} + {β ( {DC}^{T} )}_{t , l}}{{( {GS}^{T} {F}^{T} {FS}^{T} )}_{t , l} + {β ( {GCC}^{T} )}_{t , l}} & ( 3 ) \\ {S}_{k , l} = {S}_{k , l} \frac{{( {F}^{T} {XG}^{T} )}_{k , l} + γ {S}_{k , l}^{*}}{{( {F}^{T} {FSGG}^{T} )}_{k , l} + γ {S}_{k , l}} \\ A = {( \begin{matrix}1 \\ ⋮ \\ 1\end{matrix} )}_{k \times 1 matrix} \\ B = {( \begin{matrix}1 \\ ⋮ \\ 1\end{matrix} )}_{n \times 1 matrix} \\ C = {( \begin{matrix}1 \\ ⋮ \\ 1\end{matrix} )}_{l \times 1 matrix} \\ D = {( \begin{matrix}1 \\ ⋮ \\ 1\end{matrix} )}_{m \times 1 matrix} & ( 4 )\end{matrix}$$

where F_{w,k} represents a value at an element at w-th row and k-th column of F (1≦w≦N, 1≦k≦K). S_{k,l} represents a value at an element at k-th row and l-th column of S (1≦k≦K, 1≦l≦L). G_{t,l} represents a value at an element at t-th row and l-th column of G (1≦t≦M, 1≦l≦L). F^{T} represents a transposed matrix of F. G^{T} represents a transposed matrix of G. S^{T} represents a transposed matrix of S. X^{T} represents a transposed matrix of X. A^{T} represents a transposed matrix of A.

The decomposer 423 updates the first matrix, the second matrix, and the third matrix using formulas (2) through (4) to decrease the error.

The decomposer 423 calculates the error between the product of the updated first matrix, second matrix, and third matrix and the fundamental matrix (step S15).

The decomposer 423 determines whether the error determined in step S15 is equal to or below a predetermined value (step S16). If the error is equal to or below the predetermined value, the decomposer 423 completes the decomposition process. If the error is above the predetermined value, processing proceeds to step S17.

In step S17, the decomposer 423 adds 1 to i and then returns to step S13. The first matrix, the second matrix, and the third matrix are repeatedly updated until the error is equal to or below the predetermined value or until i reaches the predetermined number of iterations. At the end of the decomposition process, the first matrix, the second matrix, and the third matrix are determined in a manner such that the error between the product of the first matrix, the second matrix, and the third matrix and the fundamental matrix is approximately zero.

When the decomposition process ends, and processing proceeds to step S5 of FIG. 6, the output unit 430 outputs the fundamental matrix, the first matrix, the second matrix, and the third matrix to the display apparatus 300. Since the display apparatus 300 displays the fundamental matrix, the first matrix, the second matrix, and the third matrix, the analyzer views these matrices and analyzes the clustering results.

Examples of Matrices

Examples of the fundamental matrix used in a data analysis method and the first matrix, the second matrix, and the third matrix obtained through the data analysis method are described below.

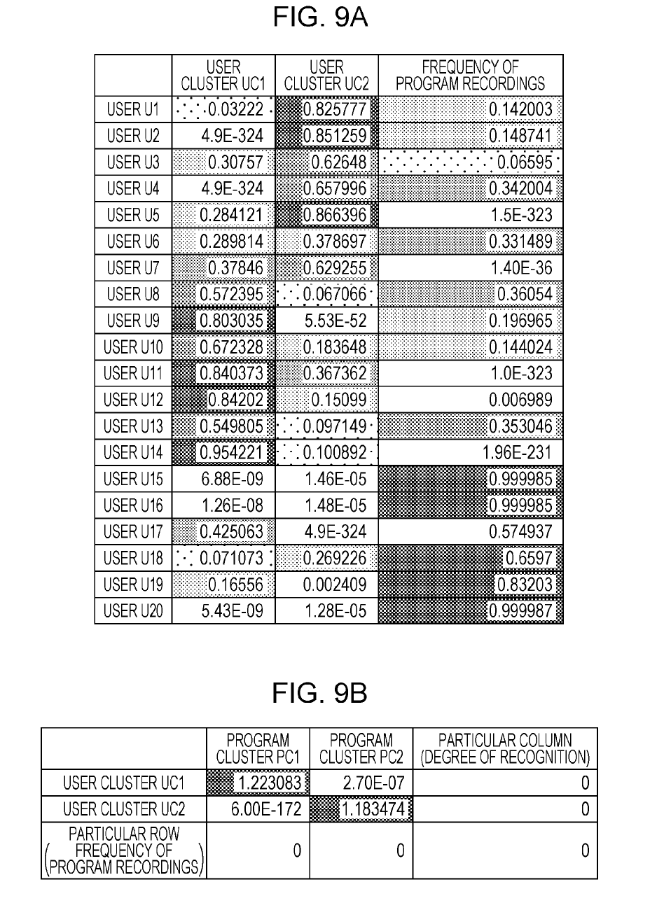

FIG. 8 illustrates an example of the fundamental matrix.

The fundamental matrix of FIG. 8 has 20 rows and 14 columns. The fundamental matrix of FIG. 8 indicates whether 20 users of users U1 through U20 have respectively recorded 14 programs P1 through P14 as 14 objects. A program recorded by a user is represented by “1”, and a program not recorded by a user is represented by “0”. “1” or “0” represents the presence or absence of a user's interest.

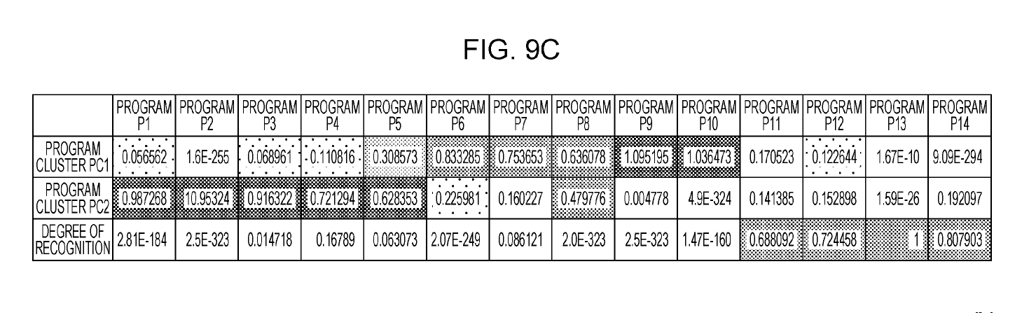

FIG. 9A through FIG. 9C illustrate examples of the first matrix, the second matrix, and the third matrix obtained as a result of a data analysis method applied to the fundamental matrix of FIG. 8. Even if the same fundamental matrix is used, the final first matrix, second matrix, and third matrix may be different depending on the values of the elements at the initialization, the convergence criteria, and the matrix updating formula.

In the example of FIG. 8, with K being 3, the third column (K-th column) of the second matrix is set to be the particular column. More specifically, the first column and the second column of the second matrix are related to columns for the user clusters UC1 and UC2. With L being 3, the third row (L-th row) of the second matrix is set to be the particular row. More specifically, the first row and the second row of the second matrix are related to columns of program clusters PC1 and PC2.

The first matrix of FIG. 9A stores at the elements thereof the degrees of relatedness of 20 persons of users U1 through U20 with the user clusters UC1 and UC2, and frequencies of program recordings. The second matrix of FIG. 9B stores at the elements thereof the degrees of relatedness between the user clusters UC1 and UC2 and the frequencies of program recordings, and program clusters PC1 and PC2 and the degrees of recognition. The third matrix of FIG. 9C stores at the elements thereof the degrees of relatedness between the program clusters PC1 and PC2 and the degree of recognition, and 14 programs P1 through P14.

The inventor has found that storing a value (falling within a predetermined range) having almost no relatedness with the user clusters UC1 and UC2 at the particular column of the second matrix generates a row indicating the degree of recognition of a program (object) (the third row in the third matrix of FIG. 9C). At the third row of FIG. 9C, the larger each value at the row representing the degree of recognition (third row), the smaller the degree of recognition, and the smaller each value at the row representing the degree of recognition, the larger the degree of recognition. The degree of recognition is an indicator indicative of how much the program of interest (object) is known to the public, and may be interpreted by popularity of that program. It may be considered that a user who does not actually record a program having a high degree of recognition may not record the program not because he does not know the program, rather than because he knows the program. Since a user may feel like the popular program is worth recording, he or she may dislike the program. Since the row indicative of the degree of recognition is generated in the third matrix, the first matrix, the second matrix, and the third matrix are updated with the decomposition process reflecting the degree of recognition therein. This allows the clustering operation to be performed in view of information indicating “dislike”.

The inventor has also found that storing a value (falling within a predetermined range) having almost no relatedness with the program clusters PC1 and PC2 at the particular row of the second matrix effectively generates a row indicating the frequency of program recordings (the third column in the first matrix of FIG. 9A). In the first matrix of FIG. 9A, the larger the value at the row indicative of the frequency of program recordings (at the third column), the lower the frequency of program recordings of the user, and the smaller the value at the row indicative of the frequency of program recordings, the higher the frequency of program recordings of the user. The frequency of program recordings is an indicator indicative of how often the user records programs. The inventor has found that if a column indicative of the frequency of program recordings is generated in the first matrix, the degree of relatedness between the users U1 through U20 and the user clusters UC1 and UC2 is stored as a value having a minimum effect of the degree of the frequency of program recordings thereon at the other columns in the first matrix subsequent to the decomposition process. In this way, users having a similar preference may be clustered regardless of the frequency of program recordings.

Since the object is a program in the first embodiment, the frequency of program recordings appears at a row in the first matrix when a value falling within the predetermined range is stored at the particular row of the second matrix. If the object is a product, the frequency of purchasing by which a user purchases (rents) the product appears at a row in the first matrix. Since the frequency of purchasing and the frequency of program recordings indicate the degree of acquisition of the objects by the user, these frequencies may be collectively referred to as the frequency of acquisitions.

In the first embodiment, the users U1 through U20 respectively correspond to the rows in the first matrix, and the programs P1 through P14 respectively correspond to the columns in the third matrix. In the second matrix, the particular column corresponds to the degree of recognition, and the particular row corresponds to the frequency of program recordings. Conversely, if the users U1 through U20 respectively correspond to the columns in the third matrix, and the programs P1 through P14 respectively correspond to the rows in the first matrix, the particular row corresponds to the degree of recognition, and the particular column corresponds to the frequency of program recordings in the second matrix. More specifically, depending on the clustering target and the relatedness of the first matrix, the second matrix, and the third matrix, the elements corresponding to the degree of recognition and the frequency of program recordings may be a row or a column in the second matrix. If the clustering operation is performed in view of the degree of recognition or the frequency of program recordings (frequency of acquisitions) alone, a value falling with the predetermined range may be stored in each element of the particular row or the particular column of the second matrix with the relatedness accounted for.

Advantages

In accordance with the first embodiment, the first matrix, the second matrix, and the third matrix are decomposed such that the product of the first matrix, the second matrix, and the third matrix approximates the fundamental matrix. The first matrix has N rows and K columns, the second matrix has K rows and L columns with each element at least one of a particular row and a particular column thereof storing a value falling within a predetermined range, and the third matrix has L rows and M columns. The clustering operation is thus performed in view of a factor by which the user has not acquired the object (a program or a product). The clustering operation accounting for a variety of information is thus performed.

In accordance with the first embodiment, information, such as “dislike”, may be assumed from the user's recording history. Without the above data analysis method, the information such as “dislike” may need to be collected. More specifically, if the clustering operation reflecting a variety of information is performed, energy consumed to collect information is saved.

Since the value falling within the predetermined range is stored on each element at the particular row or the particular column in the second matrix, the clustering operation accounting for the degree of recognition of the object and the user's frequency of acquisitions is performed.

Since the value falling within the predetermined range is approximately zero, the relatedness with the user cluster or the program cluster is reduced to a minimum and the value characteristic of the degree of recognition and the frequency of acquisitions is obtained.

Since the sums of the elements at the rows in the first matrix have approximately the same value, the values at each column indicative of the frequency of acquisitions are calculated with reference to the same value. The values of the columns are thus easily compared with each other.

Since the sums of the elements at the columns in the third matrix have approximately the same value, the values at each row indicative of the degree of recognition are calculated with reference to the same value. The values of the rows are thus easily compared with each other.

Since the first matrix, the second matrix, and the third matrix are updated such that the difference between the product of the first matrix, the second matrix, and the third matrix and the fundamental matrix decreases, the matrix decomposition is smoothly performed.

### Second Embodiment

If K and L having relatively larger values are set in the data analysis method of the first embodiment, a row similar to the particular row or a column similar to the particular column could be generated during the updating. In such a case, the precision level of the clustering operation may be lowered. If the row similar in property to the particular row or the column similar in property to the particular column is generated in the second matrix during the execution of the data analysis method, such a row or column is deleted in a second embodiment.

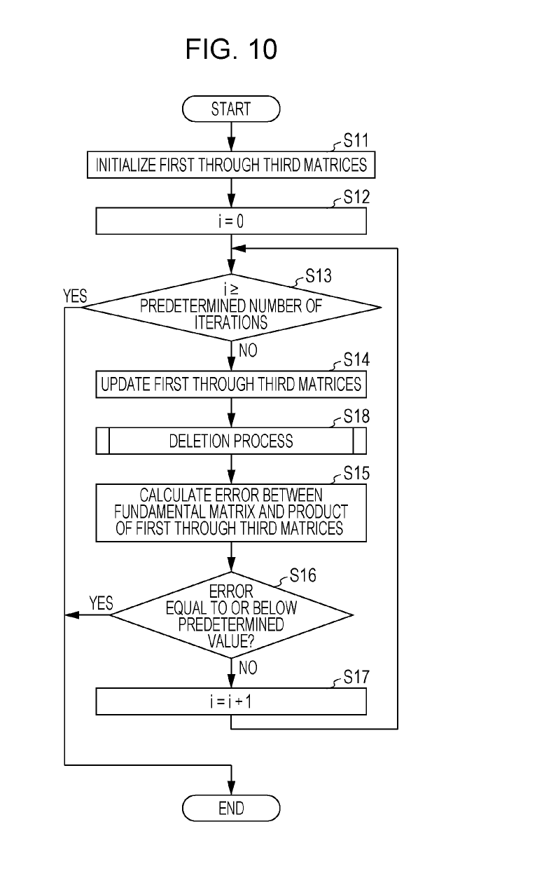

FIG. 10 is a flowchart illustrating a routine of the decomposition process of the second embodiment.

The flowchart of FIG. 10 additionally includes step S18 for the deletion process between step S14 and step S15 for the decomposition process of the first embodiment. Step S18 is described herein, and the description of the other steps is omitted.

If the row similar in property to the particular row or the column similar in property to the particular column is generated in the second matrix, the decomposer 423 deletes such a row or column in the deletion process in step S18.

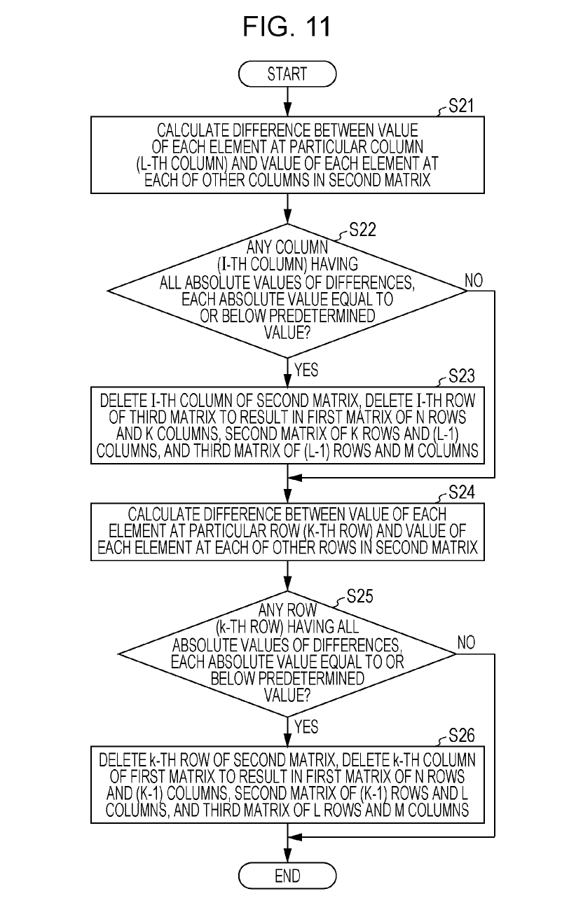

FIG. 11 illustrates a flowchart illustrating a routine of the deletion process.

The decomposer 423 calculates a difference between each value at the particular column (L-th column) and each value at each of the other columns in the second matrix (step S21).

The decomposer 423 determines whether a column (l-th column) having the absolute value of the difference between all elements is equal to or below a predetermined constant value is present (step S22). If the l-th column is present, the decomposer 423 proceeds to step S23. If the l-th column is not present, processing proceeds to step S24.

In step S23, the decomposer 423 deletes the l-th column in the second matrix and the l-th row in the third matrix, thereby updating the three matrices to the first matrix with N rows and K columns, the second matrix with K rows and (L−1) columns, and the third matrix with (L−1) rows and M columns.

In step S24, the decomposer 423 calculates a difference between the value at each element at the particular row (K-th row) with the value at each element at each of the other rows in the second matrix.

The decomposer 423 determines whether a row (k-th row) having the absolute value of the difference at each of all the elements being equal to or below a constant value is present (step S25). If the k-th row is present, the decomposer 423 proceeds to step S26. If the k-th row is not present, the decomposer 423 completes the deletion process.

In step S26, the decomposer 423 deletes the k-th row in the second matrix and the k-th column in the first matrix, thereby updating the three matrices into the first matrix with N rows and (K−1) columns, the second matrix with (K−1) rows and L columns, and the third matrix with L rows and M columns.

The predetermined constant value is a value equal to or below 0.1, for example. The operations in steps S21 through S23 and the operations in steps S24 through S26 may be reversed in order. The determinations in steps S22 and S25 are performed, based on the absolute value of the difference. If each element at the particular row or the particular column is close to zero, a determination may be made as to whether the sum of the elements at a given row or a given column is equal to or below a constant value.

Advantages

In accordance with the embodiments, if the value at each element at the k-th row other than the particular row in the second matrix falls within the predetermined range, the k-th row is deleted from the second matrix, and the k-th column is deleted from the first matrix. The three matrices are thus updated to the first matrix with N rows and (K−1) columns, the second matrix with (K−1) rows and L columns, and the third matrix with L rows and M columns. In this way, a segmentation process is sped up, and the precision level of the clustering operation is increased.

In accordance with the embodiments, if the value at each element at the l-th column other than the particular column in the second matrix falls within the predetermined range, the l-th column is deleted from the second matrix, and the l-th row is deleted from the third matrix. The three matrices are thus updated to the first matrix with N rows and K columns, the second matrix with K rows and (L−1) columns, and the third matrix with (L−1) rows and M columns. In this way, the segmentation process is sped up, and the precision level of the clustering operation is increased.

### Other Embodiments

The first and second embodiments have been discussed as an example of the technique of the disclosure. The technique of the first and second embodiments is not limited to the technique disclosed above. Change, substitution, addition, or omission of elements may be performed on the embodiments. Elements described with reference to the embodiments may be combined into a new embodiment.

In the discussion that follows, elements identical to those in the embodiments may be designated with the same reference numerals and the discussion thereof may be omitted.

In the discussion of the embodiments, the fundamental matrix is input to the data analysis apparatus 400 via the network 500. Alternatively, the data analysis apparatus 400 may directly receive (or generate) the fundamental matrix.

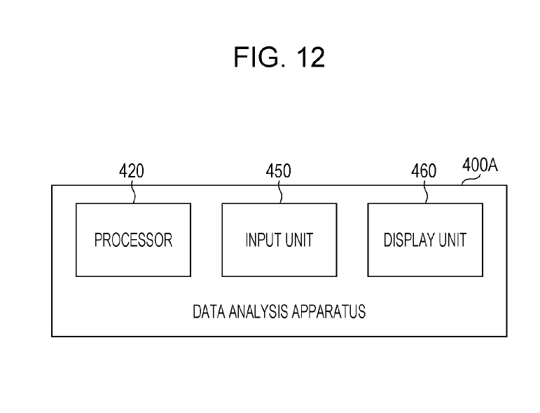

FIG. 12 is a block diagram illustrating a data analysis apparatus 400A as a modification to the embodiments.

Referring to FIG. 12, the data analysis apparatus 400A includes a processor 420, an input unit 450, and a display unit 460. The input unit 450 may be an input device, such as a keyboard, a touchpanel, or a mouse. The analyzer operates the input unit 450 to input (generate) the fundamental matrix. In other words, the input unit 450 is an acquirer. The display unit 460 is a display and displays at least one of the fundamental matrix, the first matrix, the second matrix, and the third matrix. In other words, the display unit 460 is an outputter. The data analysis apparatus 400A may include a storage unit, such as a hard disk or a memory, storing the fundamental matrix, the first matrix, the second matrix, and the third matrix.

The elements in each of the embodiments may be implemented by using dedicated hardware or by executing a software program appropriate for the elements. Elements may be implemented by a program executing unit, such as a central processing unit (CPU) or a processor, which reads the software program recorded on a hard disk or a semiconductor memory, and executes the read software program. The software program implementing an image decoding apparatus of each embodiment may be described below.

The software program causes a computer to perform a data analysis method. The data analysis method decomposes a fundamental matrix with N rows and M columns indicating relatedness with each of first N objects and each of second M objects into three matrices, and clusters at least the first objects or the second objects. The data analysis method includes acquiring the fundamental matrix having each element storing a value indicating the relatedness, setting K indicating a number of clusters of the first N objects and L indicating a number of clusters of the second M objects, decomposing the fundamental matrix into three matrices which are a first matrix, a second matrix, and a third matrix such that a product of the first matrix, the second matrix, and the third matrix approximates the fundamental matrix, the first matrix having N rows and K columns, the second matrix having K rows and L columns with each element at least one of a particular row and a particular column thereof storing a value falling within a predetermined range, the third matrix having L rows and M columns, and outputting at least one of clustering results of the first objects and the second objects by outputting at least one of the first matrix, the second matrix, and the third matrix.

In each of the embodiments, a process to be performed by a particular processor may be performed by another processor. The order of executing multiple processes may be changed, or the multiple processes may be performed in parallel.

The data analysis method in one or more aspects of the disclosure has been discussed with reference to the embodiments. The disclosure is not limited to the embodiments. Without departing from the scope of the disclosure, an embodiment may be configured by making various changes and modifications apparent to those skilled in the art to the embodiments, or by combining elements of the embodiments. Such an embodiment also falls within one or more aspects of the disclosure.

The disclosure may be used for a data analysis method for clustering, a data analysis apparatus, and a computer program. More specifically, the disclosure finds applications in a variety of fields related to clustering, such as a recommendation system or sentence sorting applications.

What is claimed is:

1. A data analysis method that decomposes a fundamental matrix with N rows and M columns indicating relatedness with each of first N objects and each of second M objects into three matrices, and clusters at least the first objects or the second objects, the data analysis method comprising:
acquiring the fundamental matrix having each element storing a value indicating the relatedness;
setting K indicating a number of clusters of the first N objects and L indicating a number of clusters of the second M objects;
decomposing the fundamental matrix into three matrices which are a first matrix, a second matrix, and a third matrix such that a product of the first matrix, the second matrix, and the third matrix approximates the fundamental matrix, the first matrix having N rows and K columns, the second matrix having K rows and L columns with each element at least one of a particular row and a particular column thereof storing a value falling within a predetermined range, the third matrix having L rows and M columns; and
outputting at least one of clustering results of the first N objects and the second M objects by outputting at least one of the first matrix, the second matrix, and the third matrix.

2. The data analysis method according to claim 1, wherein each element at the particular row and each element at the particular column stores a value falling within the predetermined range.

3. The data analysis method according to claim 1, wherein the value falling within the predetermined range is a positive value being approximately zero.

4. The data analysis method according to claim 1, wherein sums of all rows of the first matrix, each sum being a sum of the values of the elements at each row, are approximately equal to each other.

5. The data analysis method according to claim 1, wherein sums of all columns of the third matrix, each sum being a sum of the values of the elements at each column, are approximately equal to each other.

6. The data analysis method according to claim 1, wherein the decomposing comprises iterating updating the first matrix, the second matrix, and the third matrix such that a difference between the product of the first matrix, the second matrix, and the third matrix and the fundamental matrix decreases.

7. The data analysis method according to claim 1, wherein the decomposing comprises updating the first matrix, the second matrix, and the third matrix respectively into the first matrix with N rows and (K−1) columns, the second matrix with (K−1) rows and L columns, and the third matrix with L rows and M columns by deleting a k-th row of the second matrix, and a k-th column of the first matrix if a value at each element at the k-th row from among rows other than the particular row of the second matrix falls within the predetermined range.

8. The data analysis method according to claim 1, wherein the decomposing comprises updating the first matrix, the second matrix, and the third matrix respectively into the first matrix with N rows and K columns, the second matrix with K rows and (L−1) columns, and the third matrix with (L−1) rows and M columns by deleting an l-th column of the second matrix, and an l-th row of the third matrix if a value at each element at the l-th column from among columns other than the particular column of the second matrix falls within the predetermined range.

9. The data analysis method according to claim 1, wherein the first object comprises a user, and the relatedness with each element in the fundamental matrix represents presence or absence of each of N users' interest in each of the second M objects.

10. The data analysis method according to claim 1, wherein at least one of the acquiring, the setting, the decomposing and the outputting is performed by a processor.

11. A data analysis apparatus that decomposes a fundamental matrix with N rows and M columns indicating relatedness with each of first N objects and each of second M objects into three matrices, and clusters at least the first objects or the second objects, the data analysis apparatus comprising:
an acquirer that acquires the fundamental matrix having each element storing a value indicating the relatedness;
a setter that sets K indicating a number of clusters of the first N objects and L indicating a number of clusters of the second M objects;
a decomposer that decomposes the fundamental matrix into three matrices which are a first matrix, a second matrix, and a third matrix such that a product of the first matrix, the second matrix, and the third matrix approximates the fundamental matrix, the first matrix having N rows and K columns, the second matrix having K rows and L columns with each element at least one of a particular row and a particular column thereof storing a value falling within a predetermined range, the third matrix having L rows and M columns; and
an outputter that outputs at least one of clustering results of the first objects and the second objects by outputting at least one of the first matrix, the second matrix, and the third matrix.

12. A non-transitory computer-readable recording medium storing a program causing a computer to perform a process that decomposes a fundamental matrix with N rows and M columns indicating relatedness with each of first N objects and each of second M objects into three matrices, and clusters at least the first objects or the second objects, the process comprising:
acquiring the fundamental matrix having each element storing a value indicating the relatedness;
setting K indicating a number of clusters of the first N objects and L indicating a number of clusters of the second M objects;
decomposing the fundamental matrix into three matrices which are a first matrix, a second matrix, and a third matrix such that a product of the first matrix, the second matrix, and the third matrix approximates the fundamental matrix, the first matrix having N rows and K columns, the second matrix having K rows and L columns with each element at least one of a particular row and a particular column thereof storing a value falling within a predetermined range, the third matrix having L rows and M columns; and
outputting at least one of clustering results of the first objects and the second objects by outputting at least one of the first matrix, the second matrix, and the third matrix.
